(19) United States
(12) Patent Application Publication
(10) Pub. No.: US 2008/0086368 A1
(43) Pub. Date: Apr. 10, 2008

(54) Location Based, Content Targeted Online Advertising

(75) Inventors: Shannon P. Bauman, San Francisco, CA (US); Keith Schmidt, Jersey City, NJ (US); Dominic Preuss, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/539,109

(22) Filed: Oct. 5, 2006

(51) Int. Cl. G06Q 30/00

(52) U.S. Cl. 705/14

(57) ABSTRACT

An online advertisement is targeted to a publication medium (e.g., a website) based on a location of a user visiting the website, the content of the website and/or a location associated with the website content. Static and/or dynamic maps can be presented with the targeted advertisements on the website. The targeted advertisements can include a click-to-call link and/or other features for allowing a user to interact with and explore the targeted advertisement.

### RELATED APPLICATIONS

The subject matter of this application is generally related to U.S. patent application Ser. No. ______, for “Determining Advertisements Using User Interest Information and Map-Based Location Information, filed Dec. 9, 2005, Attorney Docket No. GP-680-00-US/Google-142, U.S. patent application Ser. No. 11/375,900 for “Serving Advertisements based on Content,” filed Apr. 20, 2006, Attorney Docket No. Google-31/CON1 (GP-064-01-US), U.S. patent application No. 10/314,427, for “Method and Apparatus For Serving Relevant Advertisements,” filed Feb. 26, 2003, Attorney Docket No. Google-31 (GP-064-00-US), and U.S. Provisional Patent Application No. 60/416,144, for “Methods and Apparatus for Probabilistic Hierarchical Inferential Learner,” filed Oct. 3, 2002. Each of these applications is incorporated by reference herein in its entirety.

### TECHNICAL FIELD

The subject matter of this application is generally related to online advertising.

### BACKGROUND

Interactive media (e.g., the Internet) has potential for better targeting of advertisements (“ads”). For example, some websites provide information search functionality that is based on keywords entered by the user seeking information. This user query can be used as an indicator of the type of information of interest to the user. By comparing the user query to a list of keywords specified by an advertiser, it is possible to provide some form of targeted advertisements to these search service users.

In addition to using keywords, some conventional online advertising solutions look at web page content to better target advertisements. For example, if a web page includes content related to sports, then sports-related advertisements can be targeted to that web page. While such conventional solutions can improve ad targeting, these solutions do not match a user with a physical “brick and mortar” business located in the user's geographic region or a region of interest to the user. Nor do these conventional solutions present location based information in an interactive or exploratory manner.

Some conventional online mapping products provide users with business location information within a geographic region. Such mapping products often require the user to specify a search query. Such mapping products typically do not allow advertisers to reach users that are not interacting with the mapping product. Nor do these mapping products match ads to web page content.

### SUMMARY

The deficiencies described above are overcome by the disclosed implementations of location based, content targeted online advertising. An online advertisement is targeted to a publication medium (e.g., a website) based on a location of a user (or user system) visiting the website, the content of the website and/or a location associated with the website content. Static and/or dynamic maps and other related information can be presented with the targeted advertisements on the website. The targeted advertisements can include one or more user interface elements for allowing a user to interact with and explore the targeted advertisement.

In some implementations, a method includes: receiving content; determining an ad context from the content; determining a geographic region; determining an advertisement associated with the ad context; and generating a map associated with the geographic region, the map including a marker for identifying a location in the geographic region that is associated with the advertisement.

In some implementations, a method includes: requesting an advertisement, the request including information for targeting a geographic region and determining an ad context; and receiving an advertisement associated with the ad context and a map, the map showing at least a portion of the targeted geographic region and including a marker showing a location associated with the advertisement.

In some implementations, a system includes an ad server configurable for receiving content. A context server coupled to the ad server and is configurable to determine an ad context from the content. A location server coupled to the ad server is configurable to determine a geographic region. An ad repository coupled to the ad server is configurable for providing the ad server with an advertisement associated with the ad context. A map server coupled to the ad server is configurable to generate a map containing at least a portion of the geographic region and a marker for identifying a location in the geographic region that is associated with the advertisement.

Other implementations of location based, content targeted online advertising are disclosed, including implementations directed to systems, methods, apparatuses, computer-readable mediums and user interfaces.

### DESCRIPTION OF DRAWINGS

FIG. 1A is an exemplary publication medium for presenting location based, content targeted online advertising.

FIG. 1B is a modified version of the publication medium shown in FIG. 1A, including an exemplary location based, content targeted ad.

FIG. 2 is an exemplary web page illustrating location based, content targeted online advertising.

FIG. 3 is a block diagram of an exemplary ad targeting system.

FIG. 4 is a flow diagram of an exemplary ad targeting process.

FIG. 5 is a block diagram of an exemplary ad targeting system architecture.

### DETAILED DESCRIPTION

### Technology Overview

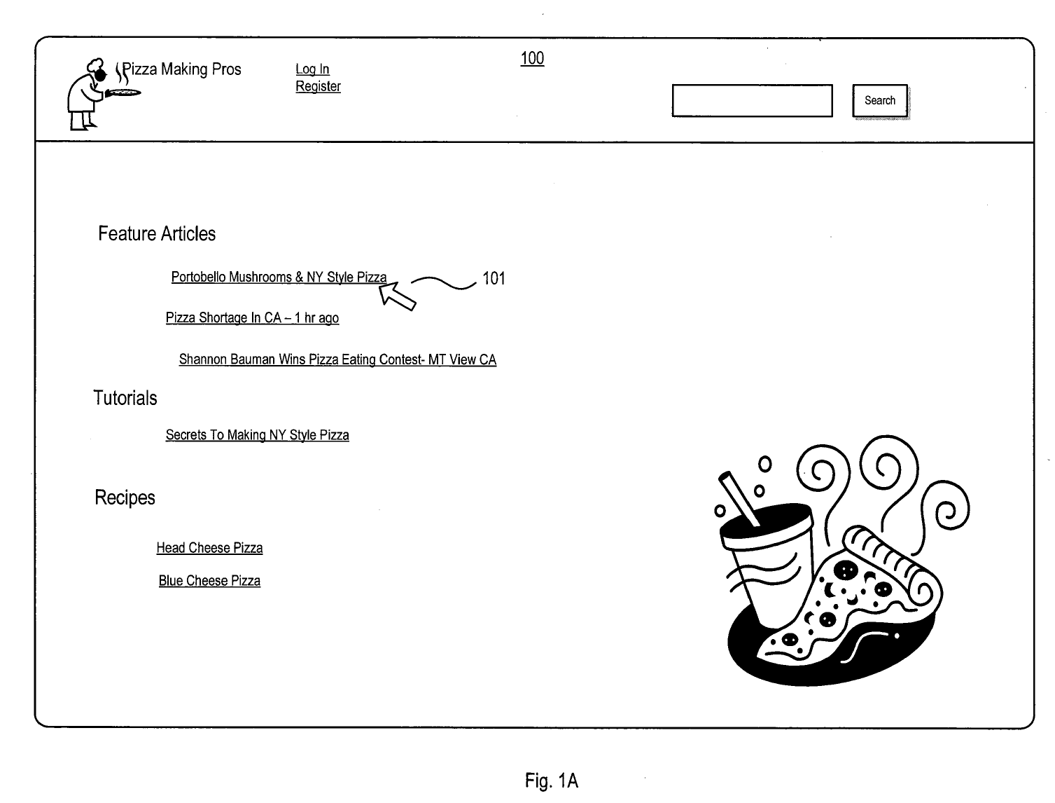

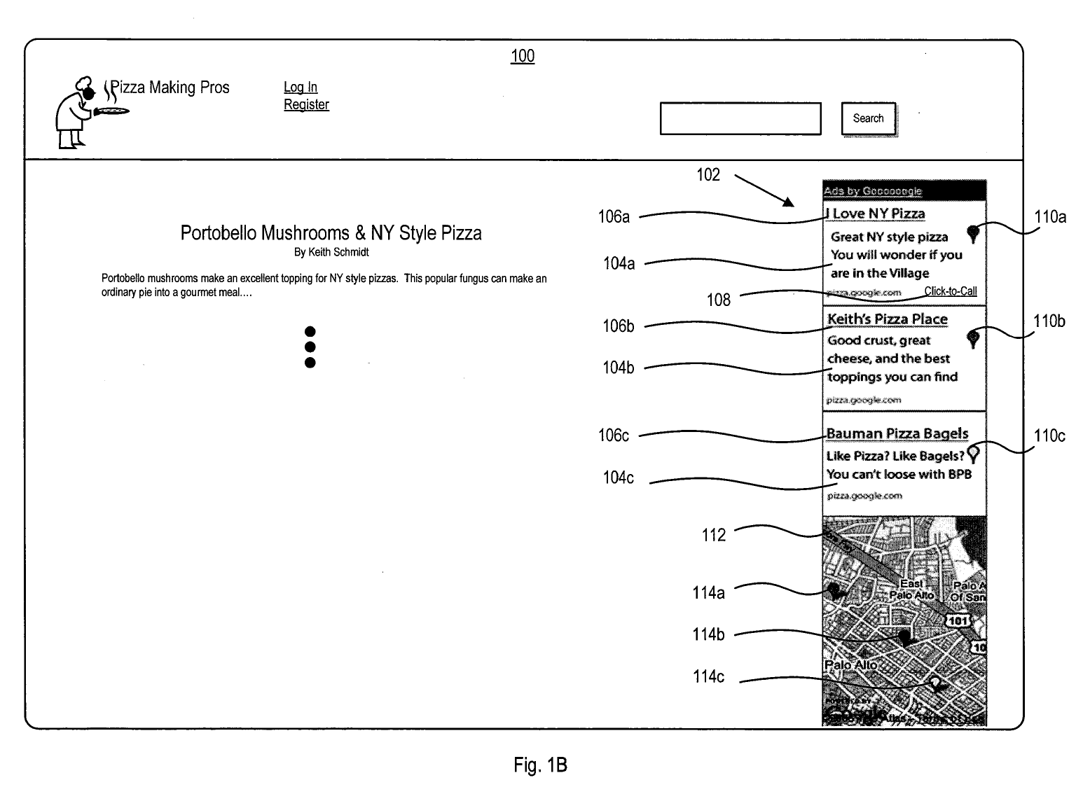

FIG. 1A is an exemplary publication medium 100 for presenting location based, content targeted online advertising. The publication medium 100 can be any medium capable of presenting advertisements, including but not limited to: electronic documents (e.g., HTML, SGML, XML, .pdf), display screens (e.g., LCD, television screen), audio, etc. In the example shown, the publication medium 100 is a web page for a website on the World Wide Web having the domain name “pizzamakingpros.com.” The content presented on the web page 100 is targeted towards consumers who are interested in making pizza. Content can be any information that is available for retrieval or viewing by a user, including but not limited to: text, graphics, photos, video, music, audio, electronic documents, software, etc. In the example shown, the web page 100 includes various articles, tutorials and recipes related to pizza. When the user visits the web page 100 and/or interacts with content presented on the web page 100 (e.g., clicking or mousing over a link to a feature article), a location based, content targeted ad is displayed, as shown in FIG. 1B.

FIG. 1B is a modified version of the publication medium 100 shown in FIG. 1A including an exemplary location based, content targeted ad. In response to a mouse click or other interaction with a link 101 (FIG. 1A), the article “Portobello Mushrooms & NY Style Pizza” is presented on the web page 100, together with a targeted advertising display 102. In the example shown, the targeted advertising display 102 includes ads 104 sponsored by three different advertisers which are related to pizza and pizza making. The targeted advertising display 102 could also present multiple ads sponsored by the same advertiser. The ads 104 can include any type of content (e.g., text, images, audio) and one or more user interface elements 106 for interacting with the ads and/or establishing connections with other resources (e.g., advertiser or retailer websites, chat rooms, forums). One or more user interface elements can be provided in the targeted advertising display for displaying and hiding contact information for each advertiser to address problems of limited space in the targeted ad display.

In the example shown, the ad 104a includes a link 108 for automatically establishing a telephone connection with the advertiser “I Love NY Pizza.” The communication link can be established using known protocols, such as Voice-Over-Internet Protocol (VoIP) and/or commercially available communication technology (e.g., Skype® voice services). Other types of communication links can be established, such as automatically establishing an Instant Messaging or chat session with an advertiser, opening an email message window, etc.

The ads 104 include markers 110 which correspond to markers 114 on a map 112 located below the targeted advertising display 102. The markers 114 show the locations of the advertisers' stores. The markers 110, 114, can be any desired shape, size or color, and can include letters, numbers or other indicia to associate the marker 110, 114, with the ads 104. The ads 104 can be presented to users in a variety of formats and are not limited to the format shown in FIG. 1B.

The map 112 can be a two-dimensional or a three-dimensional map. The map 112 can also be static and/or dynamic. In some implementations, the map 112 can be a dragged and zoomed to show detailed information. For example, the user can move the map 112 by clicking and dragging the map 112 with a pointing device (e.g., a mouse). Alternatively, the user can navigate over the map 112 (e.g., move, rotate, zoom) using one more navigation controls (e.g., buttons, sliders) which can be embedded in the map 112 or presented in a separate user interface, pane or tool bar. In addition to displaying the map 112, various map services can be provided, such as the ability to view and print driving directions to a location, together with an estimate of the time required to reach the location and the distance in miles (or other units) between the user's location and the target location. The map 112 can also provide multiple view modes by default, including street map views, satellite and high-resolution aerial photographs and street maps overlaid on satellite and high-resolution aerial photographs.

In some implementations, in addition to a map (or in place of a map), an audio file can be streamed or otherwise delivered to the user, which provides an audible description of advertiser locations in the geographic region. In some implementations, the map and advertisements can be provided to users as a fax or in an electronic document attached to an email (e.g., a .pdf file).

In some implementations, the user is provided with a search box that allows the user to search for different items or stores in the targeted geographic region or the same items or stores in a different geographic region. The user can also be provided with a means (e.g., links) for checking the availability of advertised goods or services at selected locations and/or display a listing of advertised goods or services available at the targeted geographic location (e.g., movies showing at a theatre, or show times for a particular movie).

There are several observations to be made about the example shown in FIG. 1B. First, the ads 104 are associated or “targeted” to the content presented on the web page 100, which in this example is pizza. Second, a map 112 is provided with markers 114 showing the physical, “brick and mortar” locations of businesses that provide products related to the content, which in this example are pizzerias. A third observation is that the ads 104 were selected based on the user's geographic location and/or a region of interest derived from the content of the web page 100, which in this example is Palo Alto, Calif.

The location based, content targeted ads 104 provide significant advantages over conventional targeted advertising in that the content of the web page 100 and a geographic region of interest are used together to determine relevant ads 104. Moreover, the ads 104 can be presented with a static and/or dynamic map 112 showing the locations of the advertisers' stores without the user having to invoke a separate map product (e.g., Google™ Maps, Yahoo!® Maps).

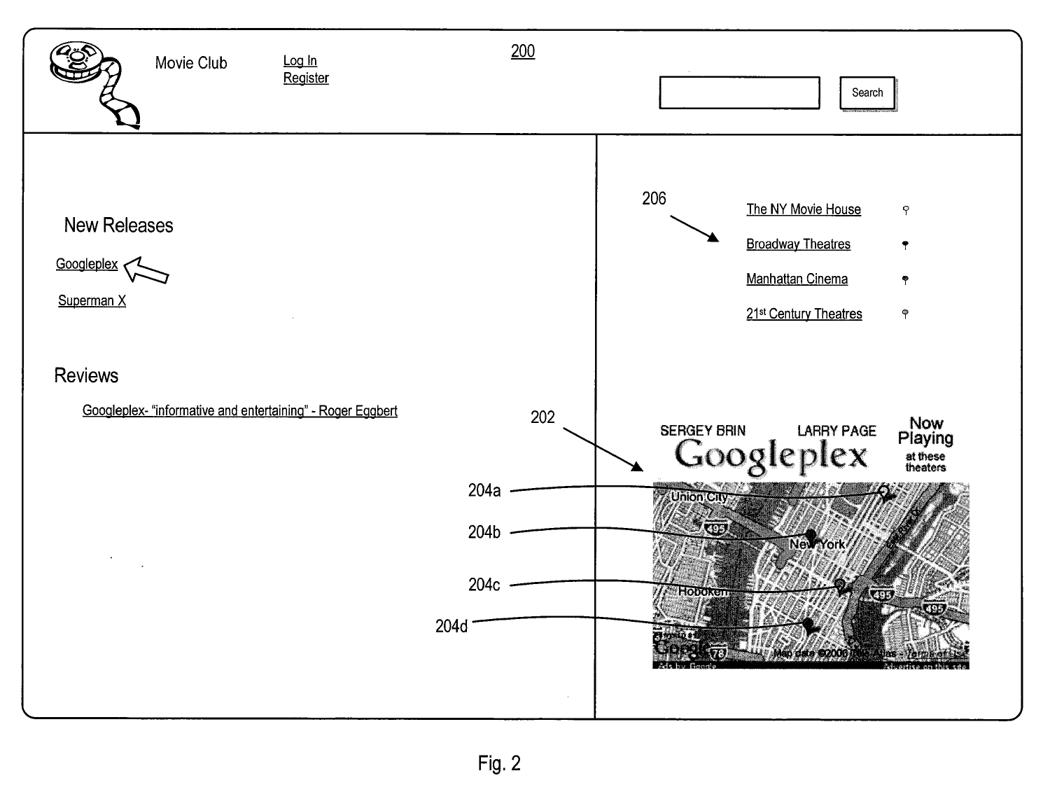

FIG. 2 is an exemplary web page 200 illustrating location based, content targeted online advertising. The web page 200 includes content related to movies (e.g., new releases, reviews). In the example shown, the user is located in Manhattan, or is located in another region but is interested in seeing a movie in Manhattan. When the user clicks the link for “Googleplex,” the targeted advertising display 202 is presented. The targeted advertising display 202 includes markers 204 showing the physical locations of theatres in Manhattan that are currently showing the feature Googleplex. These markers are associated with links 206 to theatres in Manhattan. The links 206 can direct the user to various information resources, such as show times, reviews, etc. Similar to the example shown in FIGS. 1A and 1B, the user's geographic location (Manhattan) and/or a region of interest derived from the content of the web site 200, can be used to identify theatres in Manhattan that are currently playing Googleplex. The ads 206 can be targeted to the general content of the web page 200 (e.g., movies) or to specific content (e.g., Googleplex).

### Ad Targeting System

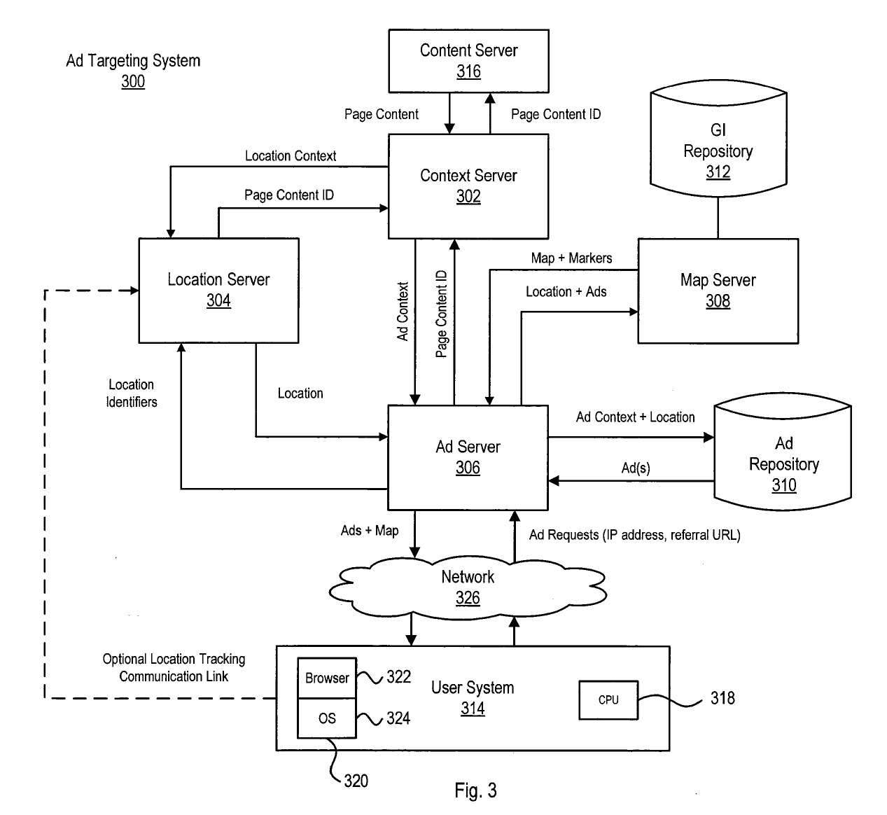

FIG. 3 is a block diagram of an exemplary ad targeting system 300. The ad targeting system 300 includes a context server 302, a location server 304, an ad server 306, a map server 308, an ad repository 310, a geographic information (GI) repository 312 and a content server 316. The system 300 is one example of an ad targeting system for delivering location based, content targeted ads to end users. Other configurations are possible. For example, the functions provided by the servers shown in FIG. 3 could be performed by a single computer or multiple computers in a network. The servers can be individual server processes run on separate computers or a single server process running on a single computer. The ad repository 310 and GI repository 312 can include one or more databases located on one or more storage devices. In some implementations, geographic information can be received directly from a positioning system, such as a global positioning system (GPS), a radio-signal-based positioning system, a wireless local-area network positioning system (WLAN-based positioning), a cellular network-based positioning system, etc.

In some implementations, the system 300 can be part of an online publishing tool, such as Google AdSense™ for Content provided by Google, Inc. (Mountain View, Calif., U.S.A.). In other implementations, the system 300 can be part of an online search engine. With a search engine a user can provide a precise geographic region that can be used by the system 300 to target ads, or the system 300 could determine a more precise geographic region by monitoring the user's search activity (e.g., scrolling, zooming, search terms) to determine the user's interest.

In operation, a user system 314 provides ad requests to the ad server 306. The user system 314 can be any device capable of presenting advertisements, including but not limited to: personal computers, personal digital assistants (PDAs), mobile phones, smart phones, media players/recorders, game consoles, television systems, electronic tablets, navigation systems, etc. In some implementations, the user system 314 includes a processor 318 and a computer-readable medium 320 (e.g., memory, hard disk). The computer-readable medium 320 can further include an operating system 322 (e.g., Windows® XP, Linux® OS) and an interface 324 (e.g., a browser). These components can provide connectivity with the ad server 306 through a network 326 (e.g., the Internet, wireless network) and receive and display targeted ads and other information on a display device (not shown) of the user system 314.

The ad server 306 provides location identifiers to the location server 304. Location identifiers include any information that can be used to determine a geographic location of a user or a location that may be of interest to a user. Some examples of location identifiers include but are not limited to: an Internet Protocol (IP) address, user profiles, user-provided information, referral URLs, location tracking data, page content, etc.

### Determining Geographic Locations

One way to determine the geographic region of a user, or a region of interest to a user, is to request geographic information from the user. For example, when a user registers on a web site, the user can be prompted to provide a home or business address. Alternatively, or additionally, an IP address can be used to determine the geographic location of the user. When the user system 314 contacts the ad server 306 to request a web page, the user system 314 passes an IP address to the ad server 306. The IP address can be provided by, for example, an Internet Service Provider (ISP). An IP address locator can use the IP address to determine the geographic region of the user. An example of an IP address locator is the IP Address Locator tool developed by Geobytes, Inc.

Referring again to the example of FIG. 1B, when a user system 314 located in Palo Alto requests an ad from the ad server 306, the ad server 306 receives an IP address with the request which is forwarded to the location server 304. An IP address locator can then use the IP address to access an IP address/location database and retrieve a geographic location associated with the IP address, which in the example shown is Palo Alto.

In addition to an IP address, the ad server 306 can also receive a referral URL, which is the URL of the page previously visited by the user. When the user system 314 contacts the ad server 306 to request a web page, the user system 314 can pass to the ad server 306 the referral URL. In some cases, the referral URL can provide information that can be used to determine the geographic region of the user or a region of interest. For example, if the referral URL was

“http://www.google.com/search?q=pizza+palo+alto+ca”,

the location server 304 can see that the user used the Google search engine, performed a search for pizza in Palo Alto, Calif., and came to the web page by, for example, clicking on a link on the search engine results page. From this information it can be assumed that the user is located in Palo Alto or that Palo Alto is a region of interest and that the ad context is pizza.

In some implementations, a service (e.g., a search engine, map product) stores information about the user and the service on the user's system. In some instances, this information is saved in a cookie. If such information includes geographic information, then that information can be potentially used to determine the location of the user.

In some implementations, the location of a user system 314 can be determined using location tracking technology, such as GPS, radio beacons, Cell-ID, Time of Arrival (TOA), Enhanced Observed Time Difference (E-OTD), etc. In such cases, the user system 314 can be tracked directly by the location server 304 using location tracking technology.

Another approach for determining the user's location or a region of interest is to examine the content of the web page the user is currently visiting or has visited in the past (e.g., a web page identified in a referral URL). For example, the ad server 306 and/or the location server 304 can send a web page content identifier (ID) to the context server 302. The page content ID is used to retrieve web page content from the content server 316, which can then be analyzed by the context server 302 to determine an ad context or location context based. The result of the analysis (e.g., ad context information) is passed to the ad server 306, which uses the result, together with location information received from the location server 304, to retrieve one or more ads from the ad repository 310.

The context server 302 can include one or more known hierarchical or non-hierarchical clustering algorithms for clustering web pages based on key features or traits (e.g., K-means, agglomerative clustering, QT Clust, fuzzy c-means, Shi-Malik algorithm, Meila-Shi algorithm, group average, single linkage, complete linkage, Ward algorithm, centroid, weighted group average). An example of a suitable clustering method is described in U.S. Provisional Patent Application No. 60/416,144, for “Methods and Apparatus for Probabilistic Hierarchical Inferential Learner.”

A clustering algorithm partitions a data set (e.g., a set of web pages) into subsets or “clusters,” so that data in each subset share a common trait or key feature. For example, if a web page includes content related to making pizza, then a clustering algorithm would detect this content (e.g., pizza) and assign the web page to one or more clusters associated with pizza.

Once a web page is assigned to one or more clusters, an ad context can be determined based on the assigned clusters. For example, the pizzmakingpros.com web page 100 shown in FIG. 1A could be assigned to a food cluster, a pizza cluster and/or a restaurant cluster, etc. The ad server 306 can use the determined ad context, together with location information received from the location server 304, to retrieve location based, content targeted ads from the ad repository 310. In some implementations, the ad repository 310 is a relational database (e.g., My SQL™) that can be queried for ads that have a particular ad context and are associated with advertisers having a physical presence in a particular geographic region, such as pizzerias in Palo Alto, Calif.

In some implementations, the ad targeting system 300 could target ads based on search terms or keywords provided by a user, either on a search engine result page, or on a page which is linked from a search engine results page, which contains a targeted advertising display. The search terms can be used to determine the geographic region of the user or a region of interest to the user, as well as the ad context. Search terms can be used with web page content and location identifiers to target relevant ads. The use of search terms to determine a user's location is described in U.S. patent application Ser. No. ______, for “Determining Advertisements Using User Interest Information and Map-Based Location Information, filed Dec. 9, 2005, Attorney Docket No. GP-680-00-US/Google-142.

Once the ad context and location are determined, the ad server 306 can send this information to the map server 308 to generate a map image that includes markers for locations associated with ads. The map server 308 is coupled to the GI repository 312, which includes data for generating static and/or dynamic maps and overlays, such as the markers 114 shown in FIG. 1B. For example, the coordinates (e.g., latitude, longitude) of an advertiser's physical, “brick and mortar” store can be stored in the GI repository 312, so that the map server 308 knows where to insert the markers in the map that it generates based on the location of the user or a region of interest provided by the location server 304. When the maps are generated, the ads and map are delivered by the ad server 306 to the user system 314 for presentation on a targeted advertising display, such as the targeted advertising display 102 shown in FIG. 1B. The targeted advertising display can be presented on any display surface, including but not limited to: a display screen (e.g., LCD), any surface capable of receiving a projection, a television screen, a navigation display, a hologram, etc.

### Ad Targeting Process

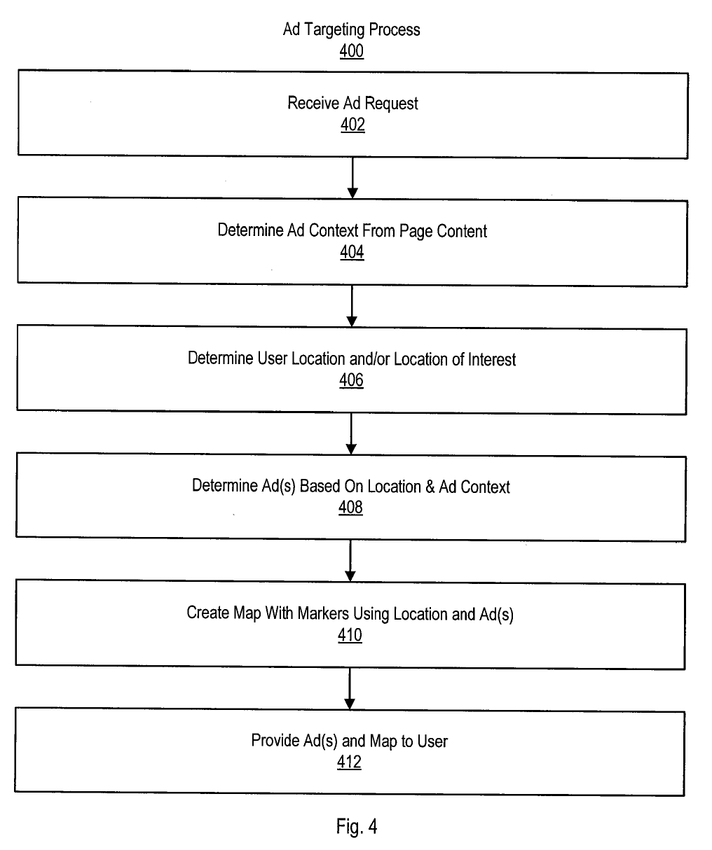

FIG. 4 is a flow diagram of an exemplary ad targeting process 400. The steps of process 400 do not have to occur in a specific order and at least some steps can occur in parallel. The ad targeting process 400 begins when an ad request is received from a user system (402). In some implementations, the ad request can include the URL of the web page which can be crawled by a context server to determine an ad context (404). The webpage can be crawled on a scheduled basis or in response to a trigger event. The context server processes the content using, for example, a clustering algorithm. The clustering algorithm identifies clusters associated with key features or traits that can be used to determine an ad context. If the web page was not previously crawled, the page can be crawled in real-time by a crawler. An example of a crawler is described in Brin, S. and Page, L. (1998), “The Anatomy of A Large-Scale Hypertextual Web Search Engine,” Computer Networks and ISDN Systems, 30(1-7):107-117, which is incorporated by reference herein in its entirety.

The process 400 also determines the user's location or a region of interest based on the web page content and/or one or more location identifies (406). The location identifiers can include an IP address, a referral URL, user profiles, user-provided information and/or web page content.

Using the ad context and location information, location based, content targeted ads can be retrieved from an ad repository (408). This can be accomplished by determining which ads fall into the ad context and which advertisers associated with those contextually relevant ads have a physical presence in the targeted geographic region. Once the ads are determined, a map and/or other information (e.g., an audio file, fax, .pdf, bit stream) can be created with markers showing the locations of the advertisers' stores or other physical properties associated with the advertiser (410). The ads and map can then be delivered to the user system for presentation on a display device of the user system (412).

The targeted ads can be displayed on the web page that includes the targeted content or the ads can be provided using a different communication medium, such as an email message or instant message. The ads and map can be delivered to the user system while the user is viewing the web page with the targeted content. The map can be static, dynamic or a combination of both. With dynamic maps, a user can explore regions near the targeted geographic region for additional information, zoom out to see the geographic context of the targeted geographic region, zoom in to see details of the targeted geographic region and otherwise explore the targeted geographic region and advertisers within the targeted geographic region. The ad can include links that redirect the user to an advertiser's web site or provide a bubble, pop-up window or other user interface element to display relevant information about the product or service being advertised. The map or associated advertisement can include a link for establishing communication with an advertiser (e.g., Skype™).

In some cases there may be too many markers displayed on a map due to a high density of advertisers in a particular geographic region. This could occur in, for example, a large city where advertisers are densely packed into small geographic regions. Too many markers could make the map unreadable, particularly on user systems with small or low resolution display screens. For such cases, a ranking or filtering system can be used to determine which advertisements to present to the user and the number of location markers to be included in a given map. The process can also determine at what scale to display the map to make the location markers easily distinguishable.

In some implementations, an ad auction can be run to determine the best N ads, and only those N ads are shown to the user. In some cases, the best N ads could be the top N advertisers, or the top N locations of a given advertiser (e.g., a burger franchise that has 30 locations in New York City). The top N locations can be determined by the distance of each store from a predetermined geographic location, alone or in combination with other factors (e.g., store popularity based on click through rate, page rank).

In some implementations, only the top x % of ads based on a computed score can have location markers included in the map. This percentage could change based on the size of the user system's display screen and resolution. For example, ads delivered to mobile phones could display a smaller percentage of ads and markers to reduce screen clutter and increase readability. The position of a given ad on the list (or whether markers associated with the given ad will be included on the map) can be determined using a score. The score can take into account available information related to geographic location and ad context or advertiser preference. For example, a score could be determined using multiple location indicators (e.g., web page content, IP address, user-provided information, user profiles, referral URLs, GPS data) to determine advertiser locations that are closest to the user. One or more scoring parameters can be weighted to increase or decrease the sensitivity of the score to such parameters. The ads can be presented to the user, such that the position of the ad in the list is based on the score. For example, higher scoring ads would be at the top of the list and would have their markers represented in the map. Lower scoring ads would be placed at the bottom of the list and may or may not have their markers represented in the map, depending on how many markers have already been included from the higher ranking ads. For those ads that are selected for presentation to the user based on a score, an estimated distance and travel time for the advertised locations can be provided. These estimates can be presented for various modes of travel (e.g., walking, car, public transportation, bicycle).

### Ad Targeting System Architecture

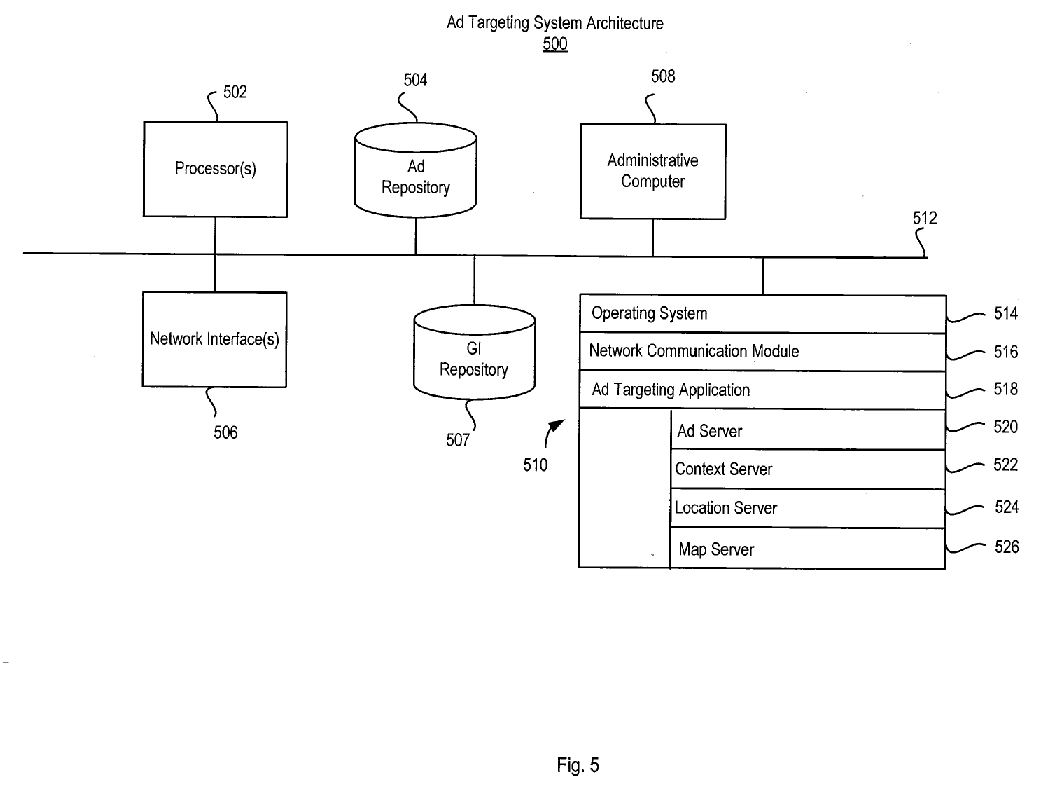

FIG. 5 is a block diagram of an exemplary ad targeting system architecture 500. Other architectures are possible, including architectures with more or fewer components. In some implementations, the architecture 500 includes one or more processors 502 (e.g., dual-core Intel® Xeon® Processors), an ad repository 504, one or more network interfaces 506, a GI repository 507, an optional administrative computer 508 and one or more computer-readable mediums 510 (e.g., RAM, ROM, SDRAM, hard disk, optical disk, flash memory, SAN, etc.). These components can exchange communications and data over one or more communication channels 512 (e.g., Ethernet, Enterprise Service Bus, PCI, PCI-Express, etc.), which can include various known network devices (e.g., routers, hubs, gateways, buses) and utilize software (e.g., middleware) for facilitating the transfer of data and control signals between devices.

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 510 further includes an operating system 514 (e.g., Mac OS® server, Windows® NT server), a network communication module 516 and an ad targeting application 518. The operating system 514 can be multi-user, multiprocessing, multitasking, multithreading, real time, etc. The operating system 514 performs basic tasks, including but not limited to: recognizing input from and providing output to the administrator computer 508; keeping track and managing files and directories on computer-readable mediums 510 (e.g., memory or a storage device); controlling peripheral devices (e.g., repositories 504, 507); and managing traffic on the one or more communication channels 512. The network communications module 516 includes various components for establishing and maintaining network connections (e.g., software for implementing communication protocols, such as TCP/IP, HTTP, etc.).

The ad targeting application 518 includes an ad server 520, a context server 522, a location server 524 and a map server 526. These components are described in reference to FIG. 3.

The architecture 500 is one example of a suitable architecture for hosting an ad targeting application. Other architectures are possible, which include more or fewer components. For example, the ad repository 504 and GI repository 507 can be the same storage device or separate storage devices. The components of architecture 500 can be located in the same facility or distributed among several facilities. The architecture 500 can be implemented in a parallel processing or peer-to-peer infrastructure or on a single device with one or more processors. The ad targeting application 518 can include multiple software components or it can be a single body of code. Some or all of the functionality of the ad targeting application 518 can be provided as a service to publishers, advertisers and end users over a network. In such a case, these entities may need to install client applications. Some or all of the functionality of the ad targeting application 518 can be provided as part of a search engine and can use information gathered by the search engine to target ads, as described in reference to FIGS. 3 and 4.

Various modifications may be made to the disclosed implementations and still be within the scope of the following claims.

What is claimed is:

1. A method comprising:
receiving content;
determining an ad context from the content;
determining a geographic region;
determining an advertisement associated with the ad context; and
generating a map of at least a portion of the geographic region, the map including a marker for identifying a location in the geographic region that is associated with the advertisement.

2. The method of claim 1, where determining a geographic region comprises:
determining the geographic region from the content.

3. The method of claim 1, where determining a geographic region comprises:
receiving an Internet Protocol (IP) address; and
determining the geographic region from the IP address.

4. The method of claim 1, where determining a geographic region comprises:
receiving a Uniform Resource Locator (URL); and
determining the target geographic region from the URL.

5. The method of claim 1, where determining a geographic region comprises:
receiving information specifying the geographic region; and
determining the geographic region from the information.

6. The method of claim 1, where determining an advertisement comprises:
storing multiple advertisements in a repository, the advertisements associated with geographic regions and ad contexts;
generating an index for retrieving an advertisement based on a specified geographic region and ad context; and
responsive to a request for an advertisement specifying a geographic region and an ad context, using the index to retrieve one or more advertisements from the repository that match the specification.

7. The method of claim 1, where generating a map comprises:
receiving information specifying the geographic region; and
generating a map image using the information.

8. The method of claim 1, further comprises:
generating one or more web pages including the map and the advertisement; and
serving the one or more web pages to a user system for presentation on a target advertising display.

9. The method of claim 1, further comprising:
inserting a user interface element in the advertisement for establishing a communication link with the one or more advertisers associated with the advertisement.

10. The method of claim 9, where establishing a communication link further comprises:
automatically establishing a telephone connection with an advertiser associated with the advertisement.

11. A method comprising:
requesting an advertisement, the request including information for targeting a geographic region and determining an ad context; and
receiving an advertisement associated with the ad context and a map, the map showing at least a portion of the targeted geographic region including a marker showing a location associated with the advertisement.

12. A system, comprising:
a processor configurable for requesting an advertisement, the request including information for targeting a geographic region and determining an ad context; and
an interface operatively coupled to the processor and configurable for receiving an advertisement associated with the ad context and a map, the map showing at least a portion of the targeted geographic region including a marker showing a location associated with the advertisement.

13. A system, comprising:
an ad server configurable for receiving content;
a context server operatively coupled to the ad server and configurable to determine an ad context from the content;
a location server operatively coupled to the ad server and configurable to determine a geographic region;
an ad repository operatively coupled to the ad server and configurable for providing the ad server with an advertisement associated with the ad context; and
a map server operatively coupled to the ad server and configurable to generate a map containing at least a portion of the geographic region and a marker for identifying a location in the geographic region that is associated with the advertisement.

14. A computer-readable medium having instructions stored thereon, which, when executed by a processor, causes the processor to perform the operations of:
receiving content;
determining an ad context from the content;
determining a geographic region;
determining an advertisement associated with the ad context; and
generating a map of at least a portion of the geographic region, the map including a marker for identifying a location in the geographic region that is associated with the advertisement.

15. The computer-readable medium of claim 14, where determining a geographic region comprises:
determining the geographic region from the content.

16. The computer-readable medium of claim 14, where determining a geographic region comprises:
receiving an Internet Protocol (IP) address; and
determining the geographic region from the IP address.

17. The computer-readable medium of claim 14, where determining a geographic region comprises:
receiving a Uniform Resource Locator (URL); and
determining the target geographic region from the URL.

18. The computer-readable medium of claim 14, where determining a geographic region comprises:
receiving information specifying the geographic region; and
determining the geographic region from the information.

19. A computer-readable medium having instructions stored thereon, which, when executed by a processor, causes the processor to perform the operations of:
requesting an advertisement, the request including information for targeting a geographic region and determining an ad context; and
receiving an advertisement associated with the ad context and a map, the map showing at least a portion of the targeted geographic region including a marker showing a location associated with the advertisement.

20. A system, comprising:
means for receiving content;
means for determining an ad context from the content;
means for determining a geographic region;
means for determining an advertisement associated with the ad context; and
means for generating a map of at least a portion of the geographic region, the map including a marker for identifying a location in the geographic region that is associated with the advertisement.
